(19) United States
(12) Patent Application Publication
(10) Pub. No.: US 2018/0329568 A1
(43) Pub. Date: Nov. 15, 2018

(54) ENCODER WITH TOUCH SCREEN

(71) Applicant: Hangzhou Xingxi Technology Co., Ltd., Hangzhou (CN)

(72) Inventors: Qiuzhu QU, Hangzhou (CN); Wenbo CHENG, Hangzhou (CN); Yunyi YAN, Hangzhou (CN); Zhengkang LUO, Hangzhou (CN); Haizhou WU, Hangzhou (CN); Yuyan ZHOU, Hangzhou (CN); Jing CHENG, Hangzhou (CN)

(73) Assignee: Hangzhou Xingxi Technology Co., Ltd., Hangzhou (CN)

(21) Appl. No.: 15/937,877

(22) Filed: Mar. 28, 2018

Related U.S. Application Data
(63) Continuation of application No. PCT/CN2017/119608, filed on Dec. 28, 2017.

(30) Foreign Application Priority Data
May 10, 2017 (CN) 201720515551.0

(51) Int. Cl. G06F 3/041; G06F 15/78; G06F 3/16

(52) U.S. Cl. CPC G06F 3/0416; G06F 1/203; G06F 3/162; G06F 15/7803

(57) ABSTRACT

The present invention relates to an encoder with touch screen. It includes a shell body, and a printed circuit board (PCB board) is disposed in the shell body. The shell body is provided with a touch screen, and the PCB board is provided with a processor, an audio decoder, a video converter, a 4G module, a Flash memory and a memory module. The present invention can be touch controlled by adopting the touch screen; the heat dissipation effect is good; and the working is stable.

### CROSS-REFERENCE TO RELATED APPLICATIONS

This application is a continuation of PCT/CN2017/119608 filed 2017 Dec. 28, which claims priority to 201720515551.0 filed in People's Republic of China on May 10, 2017, the entire contents of both are hereby incorporated by reference.

### BACKGROUND OF THE INVENTION

### Field of the Invention

The present invention relates to an encoder, and more particularly, to an encoder with touch screen.

### Description of the Related Art

Now live stream is just like a raging fire, and professional live streams for web casting, enterprise event, conference, government, sport and church event are very popular. The principle of the professional live stream is to connect a video camera (or media source) to an encoder and stream it to a live platform after the network (wireless, 4G, or wired network) is connected. Wherein, the core technology of the live stream is the encoder, and the existing encoders all need to cooperate with streaming software and operate with a computer or a mobile phone, and users also need to set relevant parameters of the existing encoders. For the user who does not have live stream experience, it is easy to have a live stream accident. Therefore, we create this machine that integrates monitoring, encoding, switching and streaming in one.

### BRIEF SUMMARY OF THE INVENTION

In view of the shortcomings of the above-mentioned solution, the present invention provides an encoder with touch control, good heat dissipation effect and capable of working in a wireless network.

A technical solution of the present invention is: an encoder with touch screen including a shell body, and a printed circuit board (PCB board) being disposed in the shell body. The shell body is provided with a touch screen, and the PCB board is provided with a processor, an audio decoder, a video converter, a 4G module, a Flash memory and a memory module. The processor includes an IIS interface, an IIC interface, an HDMI IN interface, an HDMI OUT interface, an Mipi (i.e. mobile industry processor interface) Out interface, a GMAC interface, a FLASH0 eMMC interface and a DDR3 interface. The IIS interface and the IIC interface are connected with the audio decoder, respectively, the HDMI IN interface is connected with the video converter, and the Mipi Out interface is connected with the touch screen. The GMAC interface is connected with an RJ-45 cable interface through an RGMII interface, the FLASH0 eMMC interface is connected with the Flash memory, and the DDR3 interface is connected with the memory module.

Preferably, the PCB board may be further provided with a WIFI module, the processor may further include an SDI00 UART0 interface, and the SDI00 UART0 interface may be connected with the WIFI module.

Preferably, the PCB board may be further provided with a 4G module, the processor may further include a USB HOST communication interface, and the USB HOST communication interface may be connected with the 4G module.

Preferably, the PCB board may be further provided with a switching regulator, and the processor may further include a PWR Supply interface. The PWR Supply interface may be connected with the switching regulator, and the switching regulator may be connected with a power supply output end.

Preferably, a graphite heat sink may be attached to the PCB board.

Preferably, the graphite heat sink may be attached to a rear inner wall of the shell body.

Beneficial effects of the present invention are: the encoder can be touch-controlled by adopting the touch screen; the heat dissipation effect is good by setting the graphite heat sink; the encoder can work in the wireless network by setting the WIFI module and the 4G module; and the working is stable by setting the switching regulator.

### BRIEF DESCRIPTION OF THE DRAWINGS

The present invention will be further described in detail below with reference to the accompanying drawing and specific embodiment.

FIG. 1 is a schematic diagram of the entire module of the present invention.

### DETAILED DESCRIPTION OF THE INVENTION

The technical solution of the present invention will be further described below with reference to the accompanying drawing, but the present invention is not limited to these embodiments.

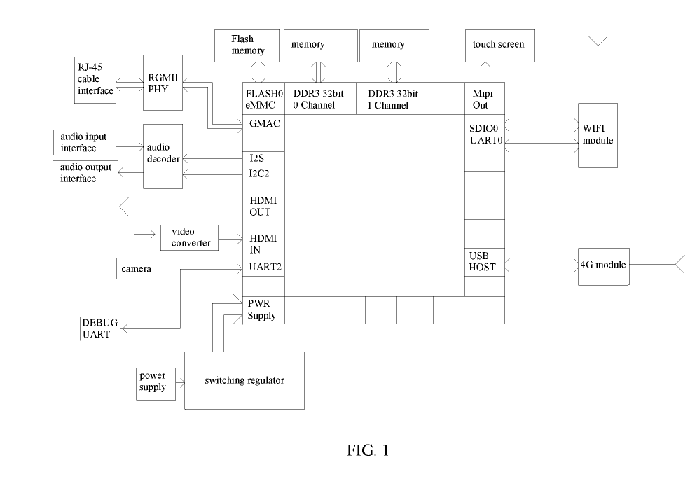

Combining with FIG. 1, an encoder with touch screen includes a shell body, and a printed circuit board (PCB board) is disposed in the shell body. The shell body is provided with a touch screen, and the PCB board is provided with a processor, an audio decoder, a video converter, a 4G module, a Flash memory, a memory module, a WIFI module, a 4G module and a switching regulator. The processor includes a IIS interface, an IIC interface, an HDMI IN interface, an HDMI OUT interface, a UART2 interface, an Mipi Out interface, a GMAC interface, a FLASH0 eMMC interface, a DDR3 interface, an SDI00 UART0 interface, a USB HOST communication interface and a PWR Supply interface.

The IIS interface and the IIC interface are connected with the audio decoder, respectively, and the audio decoder is provided with an audio input interface and an audio output interface. The HDMI IN interface is connected with the video converter, the video converter is provided with a video input interface, and the video input interface is connected with a video output interface of the camera. The UART2 interface is connected with a DEBUG UART interface as a debug serial port. The Mipi Out interface is connected with the touch screen to carry out touch setting. The GMAC interface is connected with an RJ-45 cable interface through an RGMII interface, and the RJ-45 cable interface is connected with equipment such as a server and so on to push video and audio. The FLASH0 eMMC interface is connected with the Flash memory. The DDR3 interface includes a DDR3 32 bit 0 Channel interface and a DDR3 32 bit 1 Channel interface. The DDR3 32 bit 0 Channel interface and the DDR3 32 bit 1 Channel interface are connected with the memory module, respectively. The SDI00 UART0 interface is connected with the WIFI module to push video and audio in the wireless network. The USB HOST communication interface is connected with the 4G module to push video and audio in the wireless network. The PWR Supply interface is connected with the switching regulator, and the switching regulator is connected with a power supply output end and has the effect of voltage regulation.

Further, a graphite heat sink is attached to the PCB board, and another graphite heat sink is attached to a rear inner wall of the shell body. The heat dissipation effect is good which avoids a too high temperature.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An encoder with touch screen comprising a shell body, and a printed circuit board (PCB board) being disposed in the shell body: the shell body being provided with a touch screen, the PCB board being provided with a processor, an audio decoder, a video converter, a 4G module, a Flash memory and a memory module, the processor comprising an IIS interface, an IIC interface, an HDMI IN interface, an HDMI OUT interface, an Mipi Out interface, a GMAC interface, a FLASH0 eMMC interface and a DDR3 interface, wherein the IIS interface and the IIC interface are connected with the audio decoder, respectively, the HDMI IN interface is connected with the video converter, the Mipi Out interface is connected with the touch screen, the GMAC interface is connected with an RJ-45 cable interface through an RGMII interface, the FLASH0 eMMC interface is connected with the Flash memory, and the DDR3 interface is connected with the memory module.

2. The encoder with touch screen according to claim 1, wherein the PCB board is further provided with a WIFI module, the processor further comprises an SDI00 UART0 interface, and the SDI00 UART0 interface is connected with the WIFI module.

3. The encoder with touch screen according to claim 1, wherein the PCB board is further provided with a 4G module, the processor further comprises a USB HOST communication interface, and the USB HOST communication interface is connected with the 4G module.

4. The encoder with touch screen according to claim 1, wherein the PCB board is further provided with a switching regulator, the processor further comprises a PWR Supply interface, the PWR Supply interface is connected with the switching regulator, and the switching regulator is connected with a power supply output end.

5. The encoder with touch screen according to claim 1, wherein a graphite heat sink is attached to the PCB board.

6. The encoder with touch screen according to claim 2, wherein a graphite heat sink is attached to the PCB board.

7. The encoder with touch screen according to claim 3, wherein a graphite heat sink is attached to the PCB board.

8. The encoder with touch screen according to claim 4, wherein a graphite heat sink is attached to the PCB board.

9. The encoder with touch screen according to claim 1, wherein the graphite heat sink is attached to a rear inner wall of the shell body.
